(19) United States
(12) Patent Application Publication
(10) Pub. No.: US 2010/0288091 A1
(43) Pub. Date: Nov. 18, 2010

(54) Apparatus for the Slicing of a Food Product

(75) Inventor: Guenther Weber, Gross Nemerow (DE)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Weber Maschinenbau GmbH Breidenbach, Breidenbach (DE)

(21) Appl. No.: 12/738,965

(22) PCT Filed: Sep. 12, 2008
(86) PCT No.: PCT/EP2008/007566

§ 371 Date: Jul. 21, 2010

(30) Foreign Application Priority Data
Oct. 24, 2007 (DE) 10 2007 050 858.3

(51) Int. Cl. B26D 1/00; B26D 7/26

(52) U.S. Cl. 83/13; 83/73

(57) ABSTRACT

The invention relates to a device, in particular a high-power slicing device, for slicing a food product in accordance with a selected slicing programme. Said slicing device comprises a process control and several components that can be mounted in or onto the device in accordance with the selected slicing programme. Said components respectively have a coding that clearly identifies the component and detection means for detecting the coding of a component that is mounted in or onto the device. Said detection means is connected to the process control which can determine from the detected coding whether the component has been mounted in accordance with the selected slicing programme.

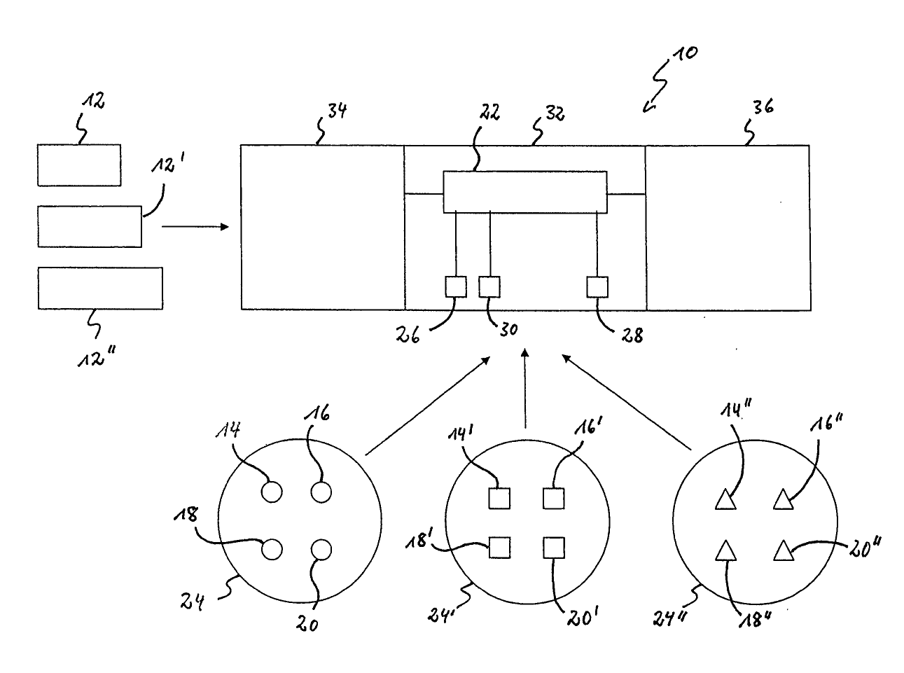

The invention relates to an apparatus, in particular to a high-performance slicer, for the slicing of a food product in accordance with a selected cutting program and having a process controller and a plurality of components which can be installed in or at the apparatus in dependence on the selected cutting program.

Such apparatus are generally known. To achieve higher cutting performance and better cutting results, these apparatus are becoming more and more complex and thus also more difficult to set and to operate. The complexity of the apparatus is to be seen alongside the operator who is less and less able to cope with the demands of the apparatus.

It is the underlying object of the invention to provide an apparatus for the slicing of a food product which is easier to operate and precludes an operating error as much as possible.

An apparatus having the features of claim 1 is provided to satisfy this object.

The apparatus in accordance with the invention is in particular characterized by the fact that the components which can be installed in or at the apparatus in dependence on the selected cutting program each have a code unambiguously identifying the component and that a detection means for the detection of the code of an installed component is provided which is connected to the process controller by means of which it can be determined from the detected code whether the component was installed in correspondence with the selected cutting program.

Typically, different machine equipment is required for the slicing of different food products which the operator of the cutting machine has to install in dependence on the application. Different cutting blades, cutting edges, product holders, product holding-down devices and/or other components guiding product or contacting product can thus, for example, have to be installed. This in particular represents a potential error source with a larger number of replaceable components since it is not always ensured that the pieces of equipment or components required for the respective application are installed in or at the cutting machine.

It is therefore the underlying idea of the invention to mark the individual components in each case by an individual code and to provide an automatic recognition of the respective component code by the cutting machine so that the operator of the cutting machine can be warned if he is installing or has installed a component which is not designed to carry out the selected cutting program.

The component number of the respective component can, for example, be transferred to the process controller by means of the code, which can be a binary code and/or can include a barcode, a color code or a numerical code. The component numbers determined in this manner are compared with the required component numbers stored in connection with the selected cutting program. On a deviation of an actually determined component number from a component number expected by the cutting program, an optical and/or acoustic error message can be output so that the machine operator can react and remedy the fault, i.e. can install the correct component.

The code is advantageously attached to an outer side of a component and/or is stored in an RFID chip connected to the component.

The detection means can include a reading unit arranged centrally at the apparatus or a plurality of reading units, in particular arranged at the respective installation locations of the components.

In addition to the detection means, a position or setting detection means can be provided which is connected to the process controller and by which the position and/or setting of at least one adjustable component can be detected which can be one of the installable components or another component. A check can be made in this manner whether the component is located in a position and/or setting preset by the selected cutting program. If this is not the case, an error message can be output to the operator of the cutting machine so that the operator can correct the position and/or setting of the component accordingly. Alternatively or additionally, the cutting machine can be designed so that a correct setting of the component preset by the selected cutting program can be carried out automatically while taking account of the actual setting detected by the position or setting detection means. In both cases, the position or setting detection means contributes to a further simplification of the operation and to a further avoidance of cases of incorrect operation of the cutting machine.

A still simpler operation of the cutting machine or a still better avoidance of an incorrect operation can be achieved in that the property of the food product to be sliced is additionally automatically taken into account.

For this purpose, a product measurement device connected to the process controller can be provided for the determination of properties of the food product to be sliced relevant to the cutting process. This makes it possible for the process controller automatically to modify cutting parameters preset by the cutting program, in particular positions and/or settings of the components which can be installed in or at the apparatus, in dependence on the determined product properties to optimize the cutting process.

Food products which are supplied to the machine can, for example, be measured with respect to their outer dimensions in order automatically to set the cutting machine ideally in dependence on the determined product dimensions. The measurement of the food product can take place, for example, by means of a scanner, of a light barrier, of a camera system and/or of scales. Depending on the measured result, the cutting position may have to be readjusted under certain circumstances to achieve an ideal cutting and placing result.

In addition, the product temperature can e.g. be determined before or during the cutting process, for example by means of an infrared thermometer or by means of a thermometer arranged in a product holder. This makes it possible also to set the cutting machine in dependence on the determined product temperature automatically so that an ideal cutting and placing result is ensured.

Alternatively or additionally to the product measurement device, a process result monitoring device connected to the product controller can furthermore be provided for the monitoring of the cutting process result. The sliced product slices can, for example, be detected by a camera system. Incorrect positions can be recognized by a suitable evaluation of the images taken. If, for example, the storage position is corrugated or if product slices continuously fold over, these are errors which can either be compensated by modified machine settings or which can be displayed by corresponding error messages since, under certain circumstances, too high a product temperature results in errors which can no longer be corrected.

The apparatus in accordance with the invention in accordance with claim 1 can be equipped either only with a position or setting detection means, only with a product measurement device or only with a process result monitoring device or with combinations thereof.

Furthermore, apparatus for the slicing of a food product are conceivable which include a position or setting detection means, a product measurement device and/or a process result monitoring device, but no detection means for the detection of a code of a component installed in or at the apparatus. Accordingly the apparatus in accordance with claims 10, 11 and 14 are also subjects of the invention.

The invention further relates to a method for the slicing of a food product (claims 16 to 19) which can in particular be carried out with the aid of the apparatus discussed above and while achieving corresponding advantages.

The invention will be described in the following purely by way of example with reference to an advantageous embodiment and to the enclosed drawing.

The only FIGURE shows a schematic representation of an apparatus in accordance with the invention for the slicing of a food product.

The apparatus shown in the FIGURE is e.g. a high-performance slicer 10 for the slicing of a food product 12 such as sausage, cheese or the like.

The cutting machine 10 includes in a manner known per se a plurality of replaceable and/or adjustable machine components which guide product or contact product and of which the cutting blade 14, the cutting edge 16, the product holder 18 and the product holding-down device 20 are named by way of example.

The cutting machine 10 furthermore has a process controller 22 in which at least one cutting program is stored in accordance with which the food product 12 is to be sliced. Typically, a plurality of cutting programs are included in the process controller 22 from which an operator of the cutting machine 10 can choose depending on the kind of food product 12 to be sliced and/or on the desired sliced result.

The cutting programs each include information on the machine equipment 24 to be used for the desired cutting process, i.e. the machine components 14-20 to be installed for the desired cutting process, as well as information on the desired positions and/or desired settings of these machine components.

As is shown in the FIGURE, the machine equipment 24 can vary from cutting program to cutting program. For example, a first piece of machine equipment 24 can be provided for the slicing of a first food product 12 having a first cutting blade 14, a first cutting edge 16, a first product holder 18, a first product holding-down device 20 and corresponding first desired positions or desired settings, whereas the slicing of a second food product 12′ can require a second piece of machine equipment 24′ having a second cutting blade, a second cutting edge 16′, a second product holder 18′, a second product holding-down device 20′ and corresponding second desired positions or desired settings. A third cutting program for the slicing of a third food product 12″ can accordingly provide a third piece of machine equipment 24″ having a third cutting blade 14″, a third cutting edge 16″, a third product holder 18″, a third product holding-down device 20″ and corresponding third desired positions or desired settings.

In operation, the operator of the cutting machine selects a suitable cutting program in dependence on the food product 12 to be sliced and/or in dependence on the desired cutting result. The operator configures the cutting machine 10 in that he installs and/or sets the required machine components 14-20 in accordance with the values of the selected cutting program.

The replaceable machine components 14-20, which are to be installed by the operator in accordance with the cutting program, are each provided with an individual code which enables an unambiguous identification of the machine components. In the present embodiment, the codes are provided by RFID chips which are attached to or embedded into the machine components 14-20. Alternatively or additionally, the codes can also be formed by color codes, barcodes or other kinds of binary codes.

The cutting machine 10 has a detection means 26 which is coupled to the process controller 22 and by which the codes of the installed machine components 14-20 can be determined. The detection means 26 can include for this purpose a reading unit arranged centrally at the cutting machine or a plurality of reading units each arranged at the installation site of the machine components 14-20.

To determine whether the operator has installed the correct machine components 14-20, i.e. the machine components preset by the selected cutting program, the codes detected by the detection means 26 are compared with the codes stored in connection with the cutting program. If the process controller 22 determines a deviation between the codes detected by the detection means 26 and the codes belonging to the selected cutting program, the process controller 22 outputs a corresponding warning to the operator via an acoustic and/or optical output means 28 so that said operator can replace an erroneously installed machine component by a correct machine component. Operation errors of the cutting machine 10 can be avoided in this manner.

In addition to the detection means 26, the cutting machine 10 can have a position or setting detection means 30 connected to the process controller 22 with whose aid it can be determined whether an adjustable machine component was correctly set in accordance with the values of the selected cutting program. The settable machine component can be one of the machine components 14-20 to be installed or another machine component which is not to be replaced.

If a comparison of the setting of a machine component determined by the position or setting detection means 30 with the setting preset by the selected cutting program shows a deviation of the actual value from the desired value, the process controller 22 also outputs a corresponding optical and/or acoustic warning signal to the operator via the output means 28 so that said operator can correct the setting of the respective machine component to the value preset by the cutting program. The position or setting detection means 30 thus contributes to an avoidance of operating errors of the cutting machine 10.

As can be seen from the FIGURE, the cutting machine 10 includes a product measurement device 34 which is positioned in front of the actual cutting unit 32 and through which the food product 12 to be sliced passes on its way to the cutting unit 32. The product measurement device 34 serves for the determination of product properties of the food product 12 relevant to the cutting process and can, for example, have a scanner, e. g. a laser scanner, and/or a light barrier to determine the cross-section and/or the length of the food product 12. A thermometer can furthermore be provided, for example an infrared thermometer, for the determination of the temperature of the food product 12.

The data determined by the process measurement device 34 are transferred to the process controller 22 in which a check is made whether the determined actual product properties differ significantly from product properties expected in accordance with the selected cutting program.

If this is the case, cutting parameters preset by the cutting program can be correspondingly adapted or modified under certain circumstances to maintain a desired cutting result. If the deviations of the product properties of the food product 12 to be sliced from the product properties expected by the cutting program are, however, so serious that the cutting program cannot react thereto by an adaptation of the cutting parameters, the process controller 22 then instigates a shutting down of the processing process.

As can furthermore be seen from the FIGURE, a process result monitoring device 36 which is connected to the process controller 22 and which serves for the monitoring of the result of the slicing process is located after the cutting unit 32. The monitoring device 36 can be a camera system, with an evaluation of the images taken by the camera system taking place either in the monitoring unit 36 itself or in the process controller 22 connected to it, with said evaluation serving to recognize errors.

If, for example, the storage position of the separated product slices is corrugated or if transferred product slice continuously fold over, these are errors which may under certain circumstances be remedied by a change of corresponding machine settings by the process controller 22. The errors can otherwise be displayed by a corresponding error message via the output means 28 and/or can result in a shutdown of the processing process, for example if too high a product temperature produces errors which can no longer be corrected.

As a result, both the codes of replaceable machine components 14-20 detectable by the detection means 26 and the position or setting detection means 30, the product measurement device 34 and the process result monitoring device 36 therefore contribute to the fact that operating errors of the cutting machine 10 are largely precluded and the cutting machine 10 can react as independently as possible to product-related errors and problems.

### REFERENCE NUMERAL LIST

10 cutting machine
12 food product
14 cutting blade
16 cutting edge
18 product holder
20 product holding-down device
22 process controller
24 machine equipment
26 detection means
28 output means
30 position or setting detection means
32 cutting unit
34 product measurement device
36 process result monitoring device

1-19. (canceled)

20. An apparatus (10), in a particular a high-performance slicer, for the slicing of a food product (12) in accordance with a selected cutting program and having a process controller (22) and a plurality of components (14-20) which can be installed in or at the apparatus (10) in dependence on the selected cutting program,
characterized in that
the components (14-20) each have a code unambiguously identifying the component; and in that a detection means (26) for the detection of the code of a component (14-20) installed in or at the apparatus (10) is provided which is connected to the process controller (22) by means of which it can be determined from the detected code whether the component (14-20) was installed in correspondence with the selected cutting program.

21. An apparatus (10) in accordance with claim 20, characterized in that the code is a binary code and/or includes a barcode, a color code or numerical code and in particular includes information on the component number of the component (14-20).

22. An apparatus (10) in accordance with claim 20, characterized in that the code is attached to an outer side of the component (14-20) and/or is stored in an RFID chip connected to the component (14-20).

23. An apparatus (10) in accordance with claim 20, characterized in that the detection means (26) includes a reading unit arranged centrally at the apparatus (10) or a plurality of reading units, in particular arranged at the respective installation sites of the components (14-20).

24. An apparatus (10) in accordance with claim 20, characterized in that the components include different kinds of cutting blades (14), cutting edges (16), product holders (18) and/or product holding-down devices (20).

25. An apparatus (10) in accordance with claim 20, characterized in that a position or setting detection means (30) connected to the process controller (22) is provided for the detection of the position and/or setting of at least one settable component (14-20).

26. An apparatus (10) in accordance with claim 20, characterized in that a product measurement device (34) connected to the process controller (22) is provided for the determination of product properties of the food product (12) relevant to the cutting process.

27. An apparatus (10) in accordance with claim 20, characterized in that a monitoring device (36), in particular a camera system, connected to the process controller (22) is provided for the monitoring of the cutting process result.

28. An apparatus (10) in accordance with claim 26, characterized in that cutting parameters preset by the cutting program, in particular positions and/or settings of the components (14-20) which can be installed in or at the apparatus (10), can be automatically modified by the process controller (22) in dependence on the determined product properties relevant to the cutting process and/or in dependence on the monitored cutting process result.

29. An apparatus (10) in accordance with claim 27, characterized in that cutting parameters preset by the cutting program, in particular positions and/or settings of the components (14-20) which can be installed in or at the apparatus (10), can be automatically modified by the process controller (22) in dependence on the determined product properties relevant to the cutting process and/or in dependence on the monitored cutting process result.

30. An apparatus (10), in particular a high-performance slicer, for the slicing of a food product (12) in accordance with a selected cutting program and having a process controller (22) and at least one component (14.20) settable in dependence on the selected cutting program,
characterized in that
the process controller (22) is connected to a position or setting detection means (30) for the detection of the position of the settable component (14-20) to determine whether the component (14-20) is located in a position in correspondence with the selected cutting program.

31. An apparatus (10), in particular a high-performance slicer, for the slicing of a food product (12) in accordance with a selected cutting program and having a process controller (22),
characterized in that
a product measurement device (34) for the determination of product properties relevant to the cutting process is connected to the process controller (22) and cutting parameters preset by the cutting program can be automatically modified by the process controller (22) in dependence on the determined product properties relevant to the cutting process.

32. An apparatus (10) in accordance with claim 26, characterized in that the product measurement device (34) includes a scanner, a light barrier, a camera system, scales and/or a thermometer, e.g. an infrared thermometer.

33. An apparatus (10) in accordance with claim 32, characterized in that the product measurement device (34) includes a scanner, a light barrier, a camera system, scales and/or a thermometer, e.g. an infrared thermometer.

34. An apparatus (10) in accordance with claim 26, characterized in that the product properties include the cross-section, length, weight and/or temperature of the product (12).

35. An apparatus (10) in accordance with claim 32, characterized in that the product properties include the cross-section, length, weight and/or temperature of the product (12).

36. An apparatus (10), in particular a high-performance slicer, for the slicing of a food product (12) in accordance with a selected cutting program and having a process controller (22),
characterized in that
a process result monitoring apparatus (36), in particular a camera system, for the monitoring of the cutting process result is connected to the process controller (22) and cutting parameters preset by the cutting program can be automatically modified by the process controller (22) in dependence on the monitored cutting process result.

37. An apparatus (10) in accordance with claim 20, characterized in that an output means (28) is provided to display an error message when an installed component (14-20) is not provided for use with the selected cutting program, a component (14-20) is not located in a position in correspondence with the cutting program and/or does not have a setting in correspondence with the cutting program, a determined product property does not correspond with a product property expected by the cutting program and/or a monitored process result does not correspond with a process result expected by the cutting program.

38. An apparatus (10) in accordance with claim 31, characterized in that an output means (28) is provided to display an error message when an installed component (14-20) is not provided for use with the selected cutting program, a component (14-20) is not located in a position in correspondence with the cutting program and/or does not have a setting in correspondence with the cutting program, a determined product property does not correspond with a product property expected by the cutting program and/or a monitored process result does not correspond with a process result expected by the cutting program.

39. An apparatus (10) in accordance with claim 32, characterized in that an output means (28) is provided to display an error message when an installed component (14-20) is not provided for use with the selected cutting program, a component (14-20) is not located in a position in correspondence with the cutting program and/or does not have a setting in correspondence with the cutting program, a determined product property does not correspond with a product property expected by the cutting program and/or a monitored process result does not correspond with a process result expected by the cutting program.

40. An apparatus (10) in accordance with claim 36, characterized in that an output means (28) is provided to display an error message when an installed component (14-20) is not provided for use with the selected cutting program, a component (14-20) is not located in a position in correspondence with the cutting program and/or does not have a setting in correspondence with the cutting program, a determined product property does not correspond with a product property expected by the cutting program and/or a monitored process result does not correspond with a process result expected by the cutting program.

41. A method for the slicing of a food product (12) in accordance with a selected cutting program by means of an apparatus (10) which includes a plurality of components (14-20) which can be installed in or at the apparatus (10) in dependence on the selected cutting program and which have a code unambiguously identifying the component, with the coding of a component (14-20) installed in or at the apparatus (10) being detected by means of a detection means (26) and with a determination being made from the detected coding whether the component (14-20) was installed in correspondence with the selected cutting program.

42. A method for the slicing of a food product (12) in accordance with a selected cutting program by means of an apparatus (10) which includes at least one component (14-20) settable in dependence on the selected cutting program, wherein a determination is made by means of a position or setting detection means (320) whether the component (14-20) is in a position in correspondence with the selected cutting program and/or has a setting in correspondence with the cutting program.

43. A method for the slicing of a food product (12) in accordance with a selected cutting program by means of an apparatus (10), wherein product properties relevant to the cutting process are determined by means of a product measurement apparatus (34) and cutting parameters preset by the cutting program are automatically modified by the process controller (22) in dependence on the determined product properties relevant to the cutting process.

44. A method for the slicing of a food product (12) in accordance with a selected cutting program by means of an apparatus (10), wherein the cutting process result is monitored by means of a process result monitoring device (36), in particular a camera system, and cutting parameters preset by the cutting program are automatically modified in dependence on the monitored cutting process result.
